(19) United States
(12) Patent Application Publication
(10) Pub. No.: US 2019/0189047 A1
(43) Pub. Date: Jun. 20, 2019

(54) DATA DRIVING DEVICE AND DISPLAY DEVICE INCLUDING THE SAME

(71) Applicant: Silicon Works Co., Ltd., Daejeon-si (KR)

(72) Inventor: Young Gi Kim, Daejeon (KR)

(73) Assignee: Silicon Works Co., Ltd., Daejeon-si (KR)

(21) Appl. No.: 16/223,685

(22) Filed: Dec. 18, 2018

(30) Foreign Application Priority Data
Dec. 20, 2017 (KR) 10-2017-0175748

(51) Int. Cl. G09G 3/20

(52) U.S. Cl. CPC G09G 3/2096; G09G 2370/045; G09G 2310/0286; G09G 2310/0291; G09G 2310/027

(57) ABSTRACT

Disclosed are a data driving device capable of variably enabling or disabling multiple channels and a display device including the same. The display driving device may include: a first latch circuit configured to latch image data; a source driving circuit configured to form multiple channels, and provide source driving signals corresponding to the image data to a display panel through the multiple channels; and a second latch circuit configured to latch control data for enabling or disabling the multiple channels in units of a predetermined number of channels, and provide a channel enable signal corresponding to the control data to the source driving circuit.

### BACKGROUND

### 1. Technical Field

The present disclosure relates to a display device, and more particularly, to a data driving device capable of variably enabling or disabling multiple channels and a display device including the same.

### 2. Related Art

A display device includes a display panel, a display driving device and a timing controller. The display driving device converts digital image data provided from the timing controller into a source driving signal, and provides the source driving signal to the display panel.

The display driving device may include multiple channels corresponding to data lines of the display panel, and each of the multiple channels may include a digital-analog converter for converting digital image data into a source driving signal and an output buffer for outputting the source driving signal to a data line of the display panel.

With the development of information technology, the display device may be applied to electronic products in various fields, and have various resolutions depending on electronic products to which the display device is applied.

Therefore, there is a demand for a technique capable of variably enabling or disabling the multiple channels of the display driving device according to the resolution of the display panel.

### SUMMARY

Various embodiments are directed to a data driving device capable of variably enabling or disabling multiple channels and a display device including the same.

In an embodiment, a display driving device may include: a first latch circuit configured to latch image data; a source driving circuit configured to form multiple channels, and provide source driving signals corresponding to the image data to a display panel through the multiple channels; and a second latch circuit configured to latch control data for enabling or disabling the multiple channels in units of a predetermined number of channels, and provide a channel enable signal corresponding to the control data to the source driving circuit.

In another embodiment, a display device may include: a display driving device configured to form multiple channels, and provide source driving signals corresponding to image data to a display panel through the multiple channels, wherein the multiple channels are enabled or disabled according to control data; a storage device in which an enable range of the multiple channels is set, and which is configured to provide enable information corresponding to the enable range; and a controller configured to generate control data for enabling or disabling the multiple channels based on the enable information, and provide the control data to the display driving device.

### BRIEF DESCRIPTION OF THE DRAWINGS

FIG. 1 is a block diagram illustrating a display driving device and a display device including the same in accordance with an embodiment of the present invention.

FIG. 2 is a block diagram illustrating a second latch circuit for latching control data of FIG. 1.

FIG. 3 is a timing diagram for describing an operation of the display driving device based on control data of FIG. 2.

FIG. 4 is a timing diagram for describing an operation of the display driving device of FIG. 1.

FIG. 5 illustrates various cases for an enable range of multiple channels.

FIG. 6 is a diagram for describing a controller that generates control data based on enable information of multiple channels, set in a storage device.

FIG. 7 is a diagram for describing an operation of controlling the multiple channels in units of a predetermined number of channels.

FIGS. 8 and 9 illustrate applications to which the embodiment of the present invention is applied.

### DETAILED DESCRIPTION

Hereafter, embodiments of the present invention will be described in detail with reference to the accompanying drawings. The terms used in this specification and claims are not limited to typical dictionary definitions, but should be interpreted as meanings and concepts which coincide with the technical idea of the present invention.

Embodiments described in this specification and configurations illustrated in the drawings are preferred embodiments of the present invention, and do not represent the entire technical idea of the present invention. Thus, various equivalents and modifications capable of replacing the embodiments and configurations may be provided at the time that the present application is filed.

The present invention discloses a data driving device capable of operating multiple channels in various manners depending on a requirement such as the resolution of a display panel, and a display device including the same.

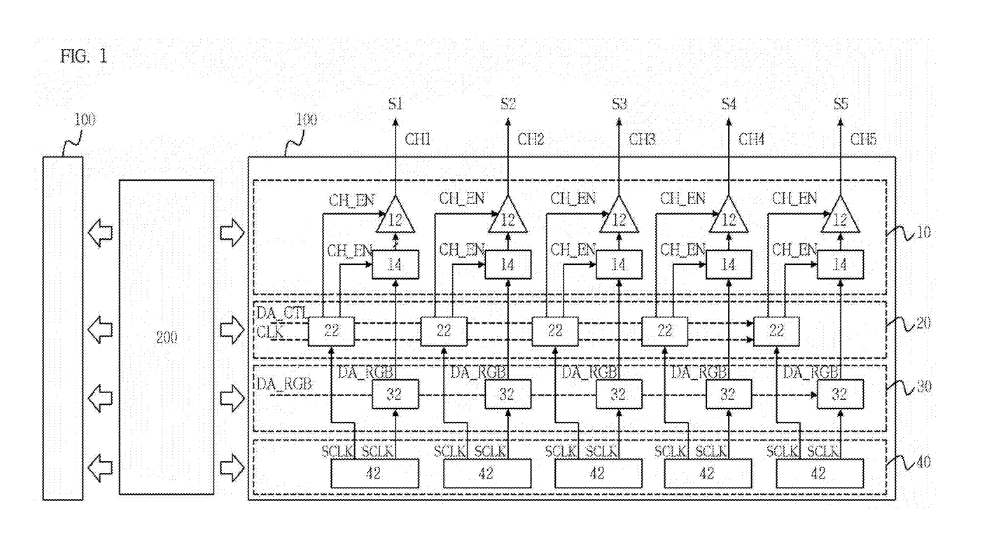

FIG. 1 is a block diagram illustrating a display driving device and a display device including the same in accordance with an embodiment of the present invention.

Referring to FIG. 1, the display device includes a display driving device 100 and a controller 200. For convenience of description, FIG. 1 illustrates only first to fifth channels CH1 to CH5, but the present embodiment is not limited thereto.

The first to fifth channels CH1 to CH5 are connected to data lines of a display panel (not illustrated), and provide source driving signals S1 to S5 corresponding to image data DA_RGB to a display panel (not illustrated). The first to fifth channels CH1 to CH5 may be configured on a basis of one channel or a predetermined number of channels.

The display driving device 100 includes a first latch circuit 30, a shift register circuit 40, a source driving circuit 10 and a second latch circuit 20.

The first latch circuit 30 latches the image data DA_RGB. The first latch circuit 30 may include a plurality of latches 32 corresponding to the first to fifth channels CH1 to CH5, and the latches 32 may latch the image data DA_RGB in response to a shift clock signal SCLK.

The shift register circuit 40 includes shift registers 42 corresponding to the first to fifth channels CH1 to CH5, and the shift registers 42 provide the shift clock signal SCLK to the first and second latch circuits 30 and 20.

The source driving circuit 10 receives the image data DA_RGB from the first latch circuit 30, and provides the source driving signals S1 to S5 corresponding to the image data DA_RGB to the display panel. The source driving circuit 10 includes digital-analog converters 14 and output buffers 12, which correspond to the first to fifth channels CH1 to CH5.

The digital-analog converters 14 select gray voltages corresponding to the image data DA_RGB as the source driving signals S1 to S5, and the output buffers 12 buffer the source driving signals S1 to S5 and provide the buffered signals to the display panel. The digital-analog converters 14 and the output buffers 12 are variably enabled or disabled according to a channel enable signal CH_EN.

The second latch circuit 20 latches control data DA_CTL for variably enabling or disabling the digital-analog converters 14 and the output buffers 12 corresponding to the first to fifth channels CH1 to CH5, and provides a channel enable signal CH_EN corresponding to the control data DA_CTL to the digital-analog converters 14 and the output buffers 12 of the source driving circuit 10.

The second latch circuit 20 may receive the shift clock signal SCLK from the shift register circuit 40, and latch the control data DA_CTL in response to the shift clock signal SCLK. Alternatively, the second latch circuit 20 may latch the control data DA_CTL in response to the clock signal CLK provided from the controller 200.

The controller 200 generates the control data DA_CTL for enabling or disabling multiple channels in units of one channel or a predetermined number of channels, based on enable information on the multiple channels which is set in a storage device, and provides the control data DA_CTL to the second latch circuit 20. In this case, an enable range of the multiple channels, corresponding to the resolution of the display panel, may be set in the storage device.

In FIG. 1, left and right blocks of the display driving device 100 forming the multiple channels may be configured and operated in the same manner.

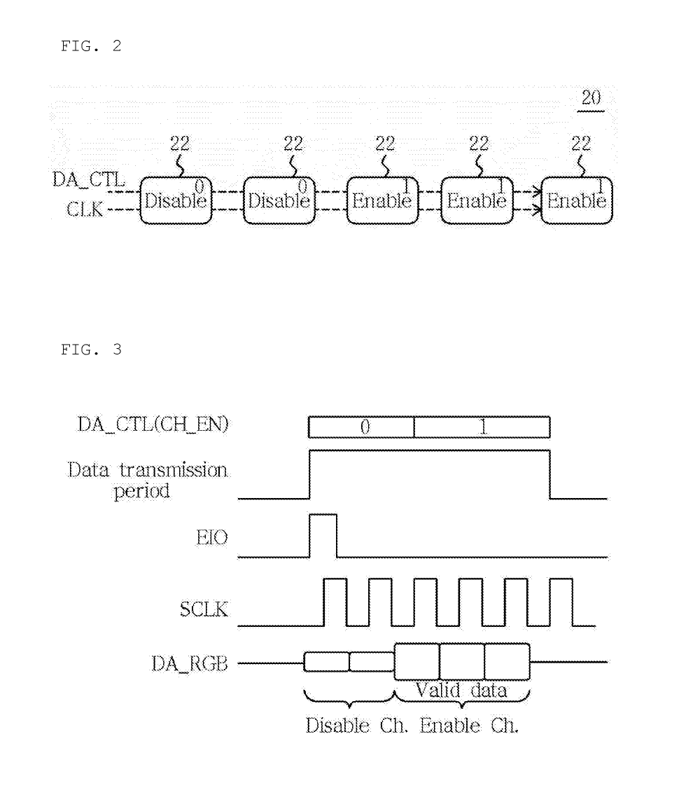

FIG. 2 illustrates the second latch circuit 20 for latching the control data DA_CTL of FIG. 1.

Referring to FIG. 2, the second latch circuit 20 includes latches 22 corresponding to the first to fifth channels CH1 to CH5. FIG. 2 exemplifies that the latches 22 latch the control data DA_CTL having logic levels of 0, 0, 1, 1 and 1. For example, when the logic level of the control data DA_CTL is 0, the corresponding channel may be disabled, and when the logic level of the control data DA_CTL is 1, the corresponding channel may be enabled.

FIG. 3 is a timing diagram for describing an operation of the display driving device 100 based on the control data DA_CTL of FIG. 2.

Referring to FIG. 3, the display driving device 100 latches the control data DA_CTL having logic levels of 0, 0, 1, 1 and 1 in the second latch circuit 20 in response to the shift clock signal SCLK generated by a start enable signal EIO, disables the first and second channels CH1 and CH2 in response to the channel enable signal CH_EN corresponding to the low-level control data DA_CTL, and enables the third to fifth channels CH3 to CH5 in response to the channel enable signal CH_EN corresponding to the high-level control data DA_CTL, in a data transfer period.

The first latches 32 of the disabled first and second channels CH1 and CH2 latch invalid image data DA_RGB, and the first latches 32 of the enabled third to fifth channels CH3 to CH5 latch valid image data DA_RGB.

In the present embodiment, the digital-analog converters 14 and the output buffers 12, which correspond to an analog region having large power consumption in the display driving device 100, are disabled in order to disable the channels. However, the first latches 32 corresponding to a digital region may be disabled.

In FIGS. 1 and 3, the multiple channels corresponding to the left and right of the controller 200 are operated in the same manner, and inside and outside disable channels are operated in the same manner.

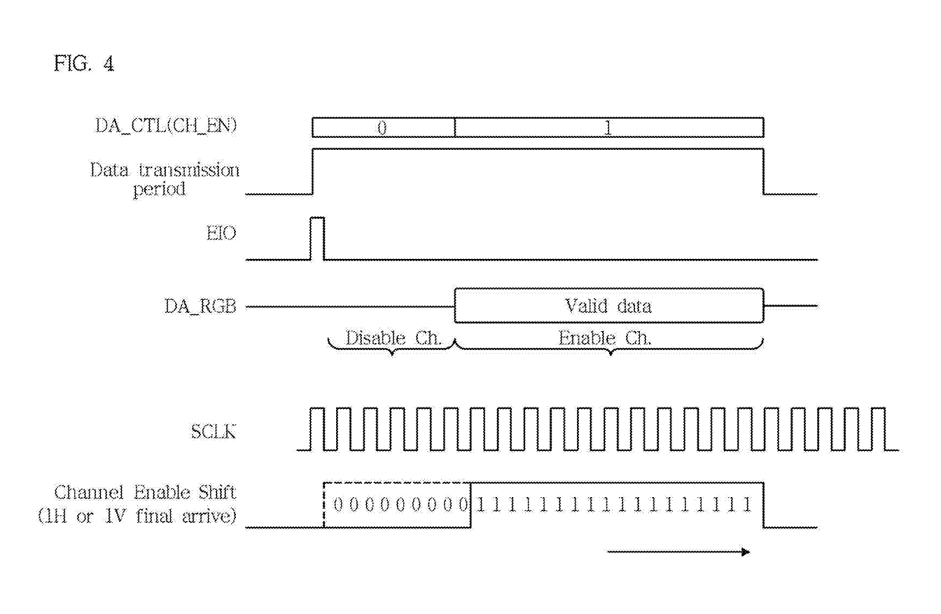

FIG. 4 is a timing diagram for describing the operation of the display driving device 100 of FIG. 1. FIG. 4 exemplifies that first to ninth channels of the multiple channels are disabled, and tenth to 25th channels are enabled.

Referring to FIG. 4, the display driving device 100 latches the control data DA_CTRL in the second latch circuit 20 in response to the shift clock signal SCLK generated by the start enable signal EIO in the data transmission period, the control data DA_CTRL having low logic levels corresponding to the first to ninth channels and high logic levels corresponding to the tenth to 25th channels. In FIG. 4, channel enable shift indicates that the control data DA_CTL latched in the second latch circuit 20 is shifted by the shift clock signal SCLK. The control data DA_CTL is shifted until the logic level of the channel enable shift is high.

The display driving device 100 disables the first to ninth channels in response to the channel enable signal CH_EN corresponding to the control data DA_CTL having logic low levels, and enables the tenth to 25th channels in response to the channel enable signal CH_EN corresponding to the control data DA_CTL having high logic levels.

The valid data DA_RGB are not latched in the first latches 32 of the disabled first to ninth channels, but latched in the first latches 32 of the enabled tenth to 25th channels.

The display driving device 100 stores the valid image data DA_RGB in the first latches 32 of the enabled channels through the operation of the shift register circuit 40 using the start enable signal EIO, in the data transmission period.

In order to minimize a malfunction due to external noise or ESD, the control data latched in the second latch circuit 20 may be periodically updated. For example, the control data may be updated on a basis of 1H or specific H, or updated on a basis of one frame or specific frame.

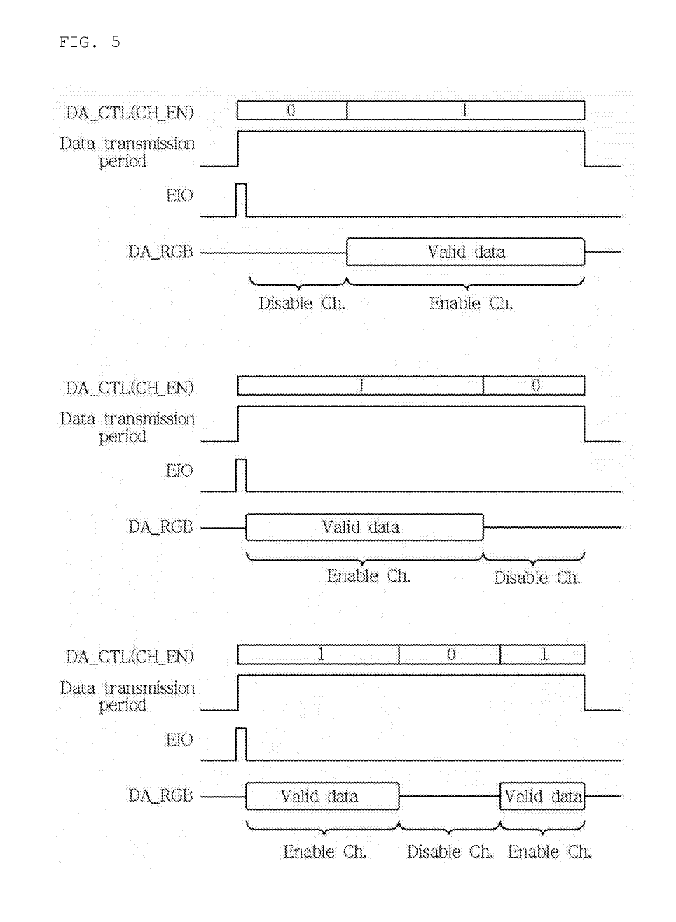

FIG. 5 illustrates various cases for the enable range of the multiple channels.

Referring to FIGS. 1 and 5, the controller 200 may set the enable range of the multiple channels in various manners.

For example, when it is assumed that there are the first to tenth channels as the multiple channels, the controller 200 may generate control data which can disable the first and second channels and enable the third to tenth channels according to the enable range set in the storage device.

Alternatively, the controller 200 may generate control data which can enable the first to eighth channels and disable the ninth and tenth channels.

Alternatively, the controller 200 may generate control data which can enable the first to sixth channels and the ninth and tenth channels and disable the seventh and eighth channels.

FIG. 6 is a diagram for describing the controller 200 that generates the control data based on the enable information of the multiple channels, set in the storage device.

Referring to FIG. 6, the enable information defining the enable range of the multiple channels may be set in the storage device. The enable information of the multiple channels may be provided as various types of signals to the controller 200. The various types of signals may be described as follows.

For example, as illustrated in FIG. 6, the enable information may be provided as signals R_Start1, R_End1, R_Start2, R_End2, EN_R_Area2, L_Start1, L_End1, L_Start2, L_End2 and EN_L_Area2 to the controller 200. Here, R_Start1 and R_End1 represent a first channel range which is enabled among the multiple channels of the right block, and R_Start2 and R_End2 represent a second channel range which is enabled among the multiple channels of the right block. Furthermore, L_Start1 and L_End1 represent a third channel range which is enabled among the multiple channels of the left block, and L_Start2 and L_End2 represent a fourth channel range which is enabled among the multiple channels of the left block. Furthermore, EN_R_Area2 and EN_L_Area2 represent whether the second channel range and the fourth channel range are enabled.

The controller 200 generates the control data DA_CTL for variably enabling or disabling the multiple channels based on the enable information of the multiple channels, set in the storage device, and provides the control data DA_CTL to the display driving device 100.

For example, the controller 200 may generate control data for enabling or disabling the multiple channels in units of one channel through the enable information of the multiple channels, set in the storage device. Alternatively, the controller 200 may generate control data for enabling or disabling the multiple channels in units of a predetermined number of channels through the enable information of the multiple channels, set in the storage device.

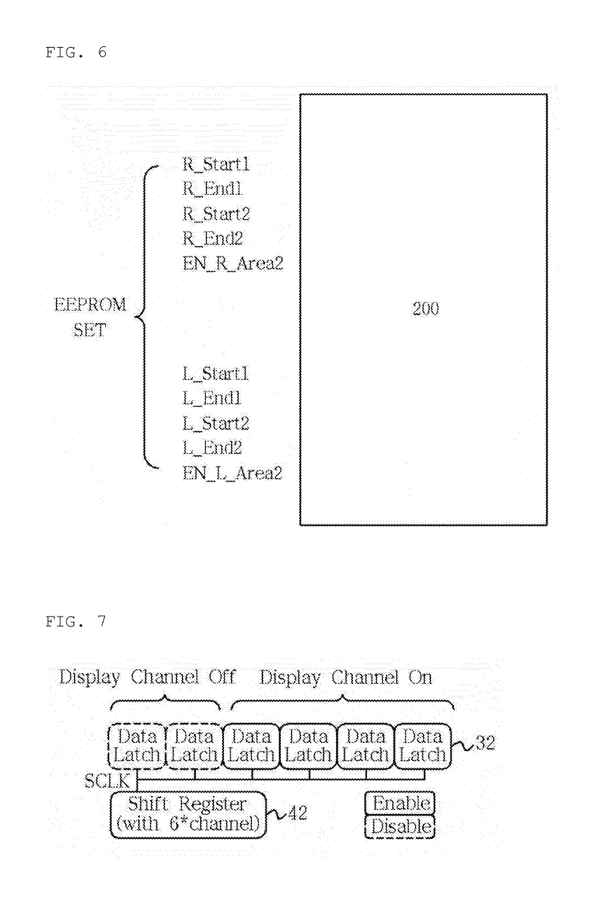

FIG. 7 is a diagram for describing the operation of controlling the multiple channels in units of the predetermined number of channels.

For example, in a channel block which is enabled or disabled by six channels, only four channels of six channels may be required to be enabled.

At this time, the controller 200 may generate control data for enabling all of the six channels in order to enable the four channels. Here, the plurality of latches 32 corresponding to the six channels may latch image data in response to the shift clock signal SCLK of the shift register 42. In FIG. 7, two disabled regions indicate that the channels are not connected to data lines of the display panel and thus turned off, and four enabled regions indicate that the channels are connected to data lines of the display panel and thus turned on.

In the present embodiment, in the channel block which is enabled or disabled by six channels, all of the six channels are enabled in order to enable some of the six channels. However, each of the channels may be enabled or disabled through control data corresponding to the channel.

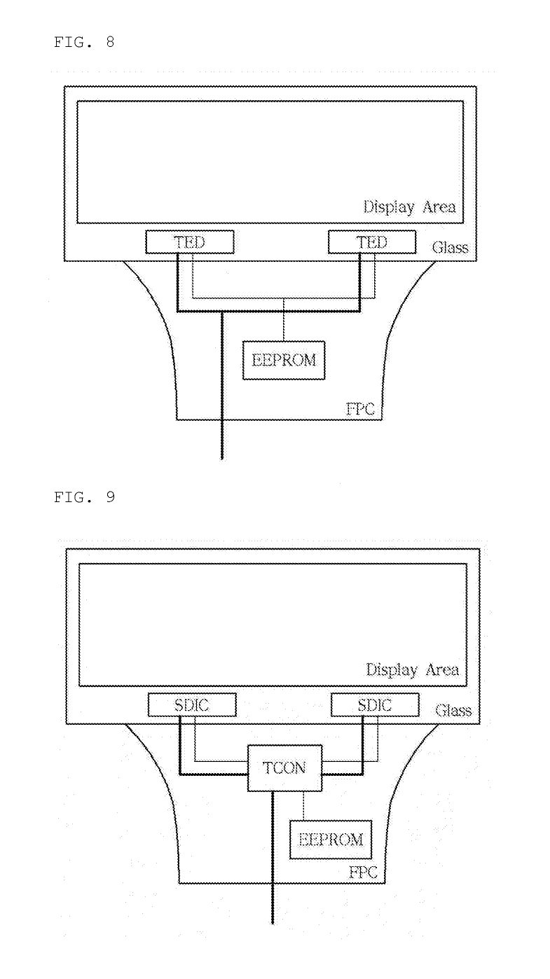

FIGS. 8 and 9 illustrate applications to which the embodiment of the present invention is applied.

Referring to FIGS. 8 and 9, the data driving device capable of variably enabling or disabling the multiple channels and the display device including the same may be applied to a timing controller embedded driver (TED) application and a source driver IC (SDIC) application having a timing controller included therein. FIG. 8 illustrates a display device to which the TED application is applied, and FIG. 9 illustrates a display device to which the SDIC application having the timing controller included therein is applied.

In accordance with the embodiments of the present invention, the multiple channels of the display driving device can be variably enabled or disabled in units of one channel or a predetermined number of channels. Thus, the display driving device can be easily applied to various electronic products to which a display device is applied.

While various embodiments have been described above, it will be understood to those skilled in the art that the embodiments described are by way of example only. Accordingly, the disclosure described herein should not be limited based on the described embodiments.

What is claimed is:

1. A display driving device comprising:
a first latch circuit configured to latch image data;
a source driving circuit configured to form multiple channels, and provide source driving signals corresponding to the image data to a display panel through the multiple channels; and
a second latch circuit configured to latch control data for enabling or disabling the multiple channels in units of a predetermined number of channels, and provide a channel enable signal corresponding to the control data to the source driving circuit.

2. The display driving device of claim 1, wherein each of the multiple channels comprises:
a digital-analog converter configured to convert the image data into the source driving signal; and
an output buffer configured to buffer the source driving signal,
wherein the digital-analog converter and the output buffer are enabled or disabled according to the channel enable signal.

3. The display driving device of claim 1, further comprising a shift register circuit configured to provide a shift clock signal to the first and second latch circuits,
wherein the second latch circuit latches the control data in response to the shift clock signal to be shifted.

4. The display driving device of claim 1, wherein the multiple channels are enabled or disabled in units of one channel according to the control data.

5. The display driving device of claim 1, further comprising a controller configured to generate the control data and provide the control data to the second latch circuit,
wherein the controller controls the multiple channels in unis of one channel or the predetermined number of channels, based on enable information of the multiple channels which is set in a storage device.

6. The display driving device of claim 5, wherein the controller is configured to periodically update the control data in the second latch circuit.

7. A display device comprising:
a display driving device configured to form multiple channels, and provide source driving signals corresponding to image data to a display panel through the multiple channels, wherein the multiple channels are enabled or disabled according to control data;
a storage device in which an enable range of the multiple channels is set, and which is configured to provide enable information corresponding to the enable range; and
a controller configured to generate control data for enabling or disabling the multiple channels based on the enable information, and provide the control data to the display driving device.

8. The display device of claim 7, wherein the storage device sets the enable range of the multiple channels to a single channel or a plurality of channels.

9. The display device of claim 7, wherein the controller controls the multiple channels in units of one channel or controls the multiple channels in units of the predetermined number of channels, in response to the enable information set in the storage device.

10. The display device of claim 7, wherein the display driving device comprises:
a first latch circuit configured to latch the image data;
a digital-analog converter configured to convert the image data into a source driving signal;
an output buffer configured to buffer the source driving signal; and
a second latch circuit configured to latch the control data provided from the controller, and provide a channel enable signal corresponding to the control data to the digital analog-converter and the output buffer.

11. The display device of claim 10, further comprising a shift register circuit configured to provide a shift clock signal to the first and second latch circuits,
wherein the second latch circuit latches the control data in response to the shift clock signal to be shifted.
